(19) United States
(12) Patent Application Publication
(10) Pub. No.: US 2004/0118134 A1
(43) Pub. Date: Jun. 24, 2004

(54) Refrigerating device

(76) Inventors: Kenzo Matsumoto, Ora-gun (JP); Noriyuki Tsuda, Ora-gun (JP); Ichiro Kamimura, Nitta-gun (JP); Toru Kawabata, Ora-gun (JP); Masato Watanabe, Ora-gun (JP); Takashi Yoshizawa, Ota-shi (JP); Hiroshi Mukaiyama, Ora-gun (JP); Ryoko Kubo, Ora-gun (JP)

Correspondence Address: J.C. Patents, Suite 250, 4 Venture, Irvine, CA, 92618, US

(21) Appl. No.: 10/729,322

(22) Filed: Dec. 4, 2003

(30) Foreign Application Priority Data
Dec. 20, 2002 (JP) 2002-369430

(51) Int. Cl. F25D 1/00; C09K 5/00; C10M 101/00; F25B 1/00

(52) U.S. Cl. 62/114; 252/67

(57) ABSTRACT

A refrigerating device is provided in which a compressor, a gas cooler, an expansion mechanism and an evaporator are sequentially connected by using refrigerant pipes. The refrigerating device uses a refrigerant mixture in which a combustible nature refrigerant and a carbon dioxide refrigerant are mixed, and an amount of the carbon dioxide refrigerant in the mixture refrigerant is 20 to 50 mass %. Alternatively, a maximum fill amount of the combustible nature refrigerant is 150 g. Therefore, the refrigerating device has a higher coefficient of performance, a high refrigerating capacity and its safety is higher than that of using only hydrocarbon refrigerant.

### CROSS-REFERENCE TO RELATED APPLICATION

This application claims the priority benefit of Japanese application serial no. 2002-369430, filed on Dec. 20, 2002.

### BACKGROUND OF THE INVENTION

1. Field of the Invention

This invention relates in general to a refrigerating device. More specifically, this invention relates a refrigerating device using a mixture refrigerant comprising a carbon dioxide refrigerant.

2. Description of Related Art

In refrigerating machines of refrigerators, vending machines and show cases, etc., chloroflurocarbon refrigerant, such as dichlorofluoromethane (R-12), or hydrochlorofluorocarbon refrigerant, such as chlorodifluoromethane (R-22), is widely used in the conventional art. However, if such refrigerant is released to the atmosphere and then reaches the ozone layer above the earth, there is a potential risk of destroying the ozone layer. Therefore, the chlorofluorocarbon freon and the hydrochlorofluorocarbon freon, which are used as refrigerants in the refrigerating machines, are forbidden or restricted. Therefore, to replace the freon of the above refrigerants, hydrofluorocarbon refrigerants, such as CH₂FCF₃ (R-134a) is used. However, in consideration of an influence to the global warming, which is another issue of the earth environment problems, even the HFC refrigerant will have the same degree of damaging effect as the HCFC-22 (CHFClF₂) of the conventional HCFC refrigerant.

In order to avoid these problems, the use of hydrocarbon (HC) refrigerant, such as propane and isobutane, etc., as the refrigerant of the refrigerating device has been practiced. However, since the HC refrigerant is combustible, it poses potential dangers of fire or explosion, which might occur when the HC refrigerant leaks from the refrigerating circuit. In particular, for a household refrigerator, since it is always located near various heat sources, leakage of the combustible refrigerant could be dangerous to cause serious accidents. In addition, for the above safety reasons, an upper limit of the filled amount of the combustible refrigerant is set at about 150 g. In practice, when considering a margin effect, there is a need to suppress the filled amount to about 100 g (50 g for the refrigerator). Therefore, in the case of using the combustible refrigerant, there is a problem that the refrigerating capacity and the use of applicable system are limited.

On the other hand, the use of carbon oxide as refrigerant of refrigerating devices is proposed, for example, as disclosed in Japanese Laid Open Publication Nos. 2002-106989 and 2002-188872. The carbon dioxide is characterized by its modulus of rupture for ozone is zero and the warming coefficient is small, so that the use of carbon dioxide is very superior in view of environment protection. However, as compared with the aforementioned hydrocarbon refrigerant, an absolute capacity of being a refrigerant gets worse. Therefore, a desired coefficient of performance (COP) cannot be obtained in the present days that power saving is required. Furthermore, regarding the reliability in material and machine, etc., carbon oxide is worse compared to the currently used refrigerant.

### SUMMARY OF THE INVENTION

According to the foregoing description, at least one object of this invention is to provide a refrigerating device having a good coefficient of performance. The safety and refrigerating capacity of the refrigerating device are higher than those devices only using the hydrocarbon refrigerant.

According to the object(s) mentioned above, the present invention provides a refrigerating device, wherein a compressor, a gas cooler, an expansion mechanism and an evaporator are sequentially connected by using refrigerant pipes. The refrigerating device uses a mixture refrigerant in which a combustible nature refrigerant and a carbon dioxide refrigerant are mixed. The amount of the carbon dioxide refrigerant in the mixture refrigerant is about 20 to 50 mass %.

The present invention further provides a refrigerating device, wherein a compressor, a gas cooler, an expansion mechanism and an evaporator are sequentially connected by using refrigerant pipes. The refrigerating device uses a mixture refrigerant in which a combustible nature refrigerant and a carbon dioxide refrigerant are mixed. A maximum fill amount of the combustible nature refrigerant is 150 g.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings.

FIG. 1 shows a relationship between a coefficient of performance (COP) and mix ratio of carbon dioxide in the mixture refrigerant.

FIG. 2 shows a conceptual diagram of an exemplary refrigerating cycle suitable for a refrigerating device of the present invention.

### DESCRIPTION OF THE PREFERRED EMBODIMENT

The refrigerating device using a mixture refrigerant is described in detail according to one preferred embodiment of the present invention.

Refrigerant Mixture

The refrigerant mixture is first described. The refrigerant mixture of used in the refrigerating device of the present invention is a refrigerant that carbon dioxide and at least one kind of combustible nature refrigerant (other than the carbon dioxide) are mixed.

Since the carbon dioxide has a low warming coefficient and is nontoxic, the use of which is very superior in environment protection and safety issues. However, the use of only carbon dioxide as the refrigerant cannot achieve a high coefficient of performance (COP, hereinafter). According to the present invention, an amount of the carbon dioxide is set at about 20 to 50 mass %, and the carbon dioxide is mixed with the combustible nature refrigerant for increasing the COP. If the carbon dioxide is less than 20 mass %, the quenching (fire extinguishing) effect cannot be effectively given for reducing the combustibility possessed by the combustible nature refrigerant, such as hydrocarbon, and as a result, it is difficult to assure the safe use thereof. In contrast, as the carbon dioxide exceeds 50 mass %, the ratio of the refrigerant with a COP higher than the carbon dioxide, is low, so that it is impossible to increase the COP of the entire system. Therefore, it is impossible for such a refrigerant mixture composition to be provided for a refrigerating device with a high refrigerating capacity.

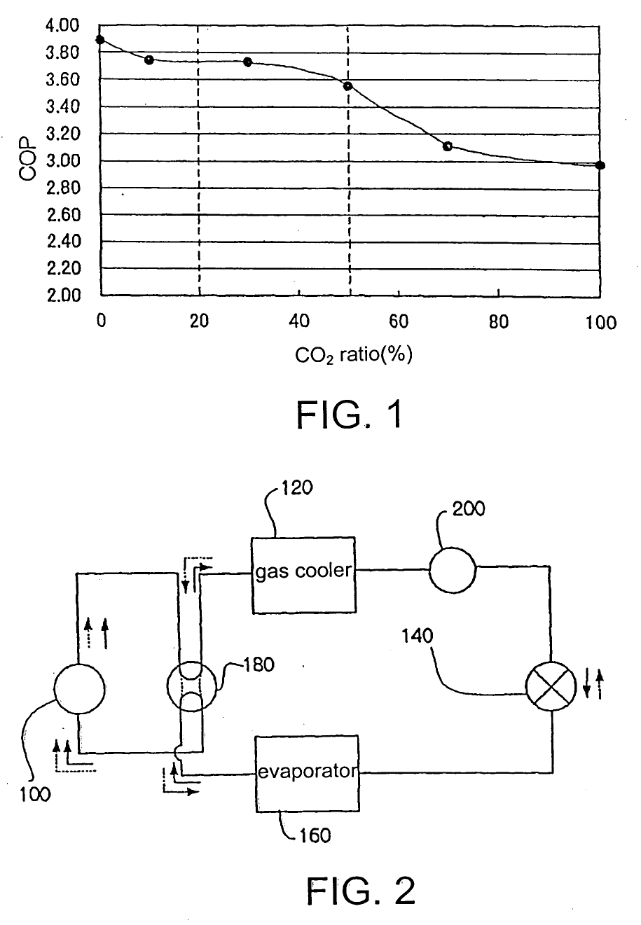

FIG. 1 shows a relationship between COP and the mixing ratio of the carbon dioxide in the mixture refrigerant of carbon dioxide and propylene. Table 1 shows the above relationship and other characteristic values.

| | ratio of CO₂ refrigerant | | | | | |
|---|---|---|---|---|---|---|
| | 100 | 70 | 50 | 30 | 10 | 0 |
| COP | 2.98 | 3.11 | 3.55 | 3.73 | 3.74 | 3.89 |
| Condense | 6376 | 4591 | 3340 | 2410 | 1580 | 1156 |
| pressure (kPa) | | | | | | |
| evaporation | 1681 | 1105 | 782 | 517 | 320 | 255 |
| pressure (kPa) | | | | | | |
| compression | 3.79 | 4.15 | 4.27 | 4.66 | 4.94 | 4.53 |
| ratio | | | | | | |
| HC refrigerant | 0 | 30 | 50 | 70 | 90 | 100 |
| wt % | | | | | | |

stimulation condition: (evaporation capacity 10 kW

CO2(R744) and propylene (R1270)

evaporation temperature: −25° C.

condense temperature: 25° C., SH: 10° C., SC: 5° C., compressor efficiency 100%

As shown in FIG. 1, in a case that the refrigerant only consists of carbon dioxide with a COP of 2.98, one can confirm that the COP increases with the increasing mixing ratio of propylene. As the propylene ratio is equal to or above 50 mass %, a COP that is close the case of a refrigerant consisting only propylene can be obtained.

The aforementioned property can be achieved not only by mixing propylene, but also by mixing other nature refrigerants of various hydrocarbons. According the above property, even though a fixed amount (20 to 50 mass %) of carbon dioxide is mixed with the nature refrigerant having a COP higher than the carbon dioxide, the COP is not reduced. Therefore, by mixing the refrigerant (such as hydrocarbon refrigerant, etc.) in an amount that was previously restricted with carbon dioxide, the refrigerant mixture can be safely applied to a system whose absolute capacity is high and not suitable for refrigerants consisting of only the hydrocarbon refrigerant.

In addition, as described above, various problems will occur with regard to the safety issues in a case of only using the hydrocarbon refrigerant, such as propylene. On the other hand, the carbon dioxide is almost nontoxic and possesses a quenching effect, and therefore, by mixing an appropriate amount of carbon dioxide and hydrocarbon refrigerant, the combustibility of the hydrocarbon refrigerant can be reduced. By only adding the carbon dioxide to the hydrocarbon refrigerant, a high COP can be maintained and the combustibility of the hydrocarbon refrigerant can be effectively reduced.

The nature refrigerant to be mixed with the carbon dioxide can be hydrocarbons, such as ethane, propane, propylene, butane, isobutane and pentane, etc., or ammonia, for example. Among which, adding hydrocarbon is preferred. Since these nature refrigerants have a small warming coefficient, the usage of the nature refrigerants is very significant in consideration of the earth environment issues. Particularly, the combination of carbon dioxide and the hydrocarbon, it is advantageous in handling the refrigerant mixture because of either nontoxicity or low toxicity. Furthermore, although the hydrocarbon is combustible as describe above, the safety of its use can be increased and improved by mixing with the noncombustible carbon dioxide. The refrigerant (other than the carbon dioxide) to be mixed can comprise at least one kind of various combustible refrigerants (such as artificial refrigerants, etc.) other than the nature refrigerants. However, in view of the environment protection, it is preferable to only add the combustible natural refrigerant to prepare the refrigerant mixture.

Refrigerating Cycle and Refrigerating Device

Next, a refrigerating cycle suitable for the refrigerating device of the present invention is described in detail. The refrigerating cycle comprises a compressor, a gas cooler, an expansion mechanism and an evaporator, and these components are sequentially connected by refrigerant pipes. The aforementioned mixture refrigerant is circulated in the refrigerating cycle.

FIG. 2 illustrates a conceptual diagram of an exemplary refrigerating cycle. As shown in FIG. 2, the refrigerating cycle comprises a compressor 100, a gas cooler 120, an expansion mechanism 140, an evaporator 160, a four-way valve 180 and a drying device 200, all of which are sequentially connected by refrigerant pipes that are depicted by solid lines. Further in FIG. 2, solid and dash arrow signs depict flow directions of the refrigerant, of which the solid arrow shows a case of performing an ordinary cooling process and the dash arrow shows a case of performing a defrosting or heating process. In FIG. 2, the drying device 200 is exemplarily disposed between the expansion mechanism 140 and the gas cooler 120. However, the position of the drying device 200 is not limited thereto, the drying device 200 can be also arranged at a location at the low pressure side depending on the conditions.

In an example of cooling an interior space, a high-temperature and high-pressure refrigerant gas, compressed by the compressor 100, passes through the four-way valve 180 and then is cooled by the gas cooler 140, so as to become a low temperature and high pressure refrigerant liquid. The refrigerant liquid is then depressurized by the expansion mechanism 140 (for example, a capillary tube, a temperature-type expansion valve, etc.) and becomes a low-temperature and low-pressure liquid that only contains little gas. The low-temperature and low-pressure liquid then reaches the evaporator 160, absorbs heat from the air in the interior room, and then evaporates. The evaporated liquid passes through the four-way valve 180 again and then reaches the compressor 100. As a result, the interior space is cooled.

In a case that the evaporator is defrosting or heating, the four-way valve 180 is switched such that the refrigerant flows along the path depicted by the dashed arrow signs. The flow direction of the refrigerant is reversed to the direction of the case of performing the cooling process. By switching the flow direction of the refrigerant to a reverse direction, the evaporator 160 and the gas cooler 120 are switched, so that the defrosting and the heating process can be performed.

The refrigerating device of the present invention has the aforementioned refrigerating cycle. Further, since the refrigerating device of the present invention uses the refrigerant mixture with a high coefficient of performance, and therefore, a larger refrigerating device can be used. Namely, if a maximum fill amount of the combustible nature refrigerant in the mixture refrigerant is 150 g, a high coefficient of performance of the nature refrigerant can be maintained, and the safety of the usage thereof can be also achieved. In this case, from the viewpoint of maintaining a high coefficient of performance, a lower limit of the fill amount of the combustible nature refrigerant is preferably at least 50 g, and 85 g is much better.

Examples that the refrigerating device of the invention is suitable for applying thereto are a heat pump unit of carbon dioxide hot-water supply system, a heat pump unit of carbon dioxide hot-water supply and heating machine, a refrigerating cycle of carbon dioxide vending machine, a refrigerating cycle of carbon dioxide refrigerant refrigerating machine, a heating machine of carbon dioxide direct expansion type and an air-conditioning machine of carbon dioxide direct expansion type.

So long as a refrigerant device has the aforementioned structure (aforementioned refrigerant mixture and the refrigerating cycle), the refrigerating device of the invention is applicable in a variety of well-know means, etc. For example, the refrigerating machine oil used in the compressor 100 is important and used as a lubricant oil that is sealed in the compressor 100. The refrigerating machine oil used in the refrigerating device of the invention can be ordinary mineral oil, ether series synthetic oil, or fluorine series synthetic oil, etc. The mineral oil can be paraffin oil or naphthene oil, etc. In addition, the ether series synthetic oil can be polyvinyl ether or polyalkylene glycol, etc. The ester series synthetic oil can be polyester oil or carbonate ester, etc. Preferably, the ester series synthetic oil uses polyester reacted from poly alcohol and polyprotic carboxylic acid. Among which, it is preferred to use polyol ester series oil that is synthesized from fatty acid and poly alcohol that is selected from pentaerythriol (PET), trimethylol propane (TMP) and neopentyl (NPG). In a case of using hydrocarbon refrigerant, it is preferable to use the mineral oil as the aforementioned refrigerating machine oil. In addition, one or more refrigerating machine oils can be mixed as the refrigerating machine oil.

It is preferred that the denaturation of the refrigerating machine oil (decomposition, oxidation, degradation, and creation of sludge, etc.) and the denaturation of the material of the refrigerating cycle are prevented by adding additives of such as defoaming agent, antioxidant, water and/or acid scavenger, extreme pressure additive or abrasion resistance promoter, metal deactivator, especially cooper deactivator, etc. into the above refrigerating machine oil. In addition, heat resistance promoter, anti-corrosion agent and anti-rust agent, etc. can be also suitably added.

In summary, according to the present invention, the refrigerant mixture has a good coefficient of performance, and its safety is higher than the case of using only the hydrocarbon refrigerant. Therefore, the refrigerant mixture of the present invention can be supplied to a refrigerating device having a high refrigerating capacity (can be applied to a larger refrigerating device).

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

What is claimed is:

1. A refrigerating device, wherein a compressor, a gas cooler, an expansion mechanism and an evaporator are sequentially connected by using refrigerant pipes, characterized in that the refrigerating device uses a refrigerant mixture in which a combustible nature refrigerant and a carbon dioxide refrigerant are mixed, and wherein an amount of the carbon dioxide refrigerant in the mixture refrigerant is 20 to 50 mass

2. A refrigerating device, wherein a compressor, a gas cooler, an expansion mechanism and an evaporator are sequentially connected by using refrigerant pipes, characterized in that the refrigerating device uses a refrigerant mixture in which a combustible nature refrigerant and a carbon dioxide refrigerant are mixed, and wherein a maximum fill amount of the combustible nature refrigerant is 150 g.
